(19) United States
(12) Patent Application Publication
(10) Pub. No.: US 2015/0009227 A1
(43) Pub. Date: Jan. 8, 2015

(54) COLOR GRADING PREVIEW METHOD AND APPARATUS

(71) Applicants: Markus E. Loeffler, Altadena, CA (US); Arden Ash, Los Angeles, CA (US); Brian J. Gaffney, Thousand Oaks, CA (US); Daniel G. Lion, Pasadena, CA (US); Robert C. Rodriguez, Sun Valley, CA (US)

(72) Inventors: Markus E. Loeffler, Altadena, CA (US); Arden Ash, Los Angeles, CA (US); Brian J. Gaffney, Thousand Oaks, CA (US); Daniel G. Lion, Pasadena, CA (US); Robert C. Rodriguez, Sun Valley, CA (US)

(73) Assignee: Thomson Licensing, Issy de Moulineaux (FR)

(21) Appl. No.: 14/380,394

(22) PCT Filed: Jul. 3, 2012
(86) PCT No.: PCT/US2012/045400

§ 371 Date: Aug. 22, 2014

Related U.S. Application Data
(60) Provisional application No. 61/616,186, filed on Mar. 27, 2012.

(51) Int. Cl. G06T 11/00; G06F 17/30; G06F 3/0482

(52) U.S. Cl. CPC G06T 11/001; G06F 3/0482; G06F 17/3025
USPC 345/594

(57) ABSTRACT

A method for previewing a color graded image commences by first obtaining color metadata corresponding to a sample image appearance selected by a user from among a set of different sample image appearances, each sample image appearance having associated color metadata. The color metadata corresponding to the selected sample image appearance is stored with an image file the user has selected for color grading. The color metadata corresponding to the selected sample image appearance is applied to the image file to generate a preview of the image file, as it would appear when color graded with the color metadata.

### CROSS-REFERENCE TO RELATED APPLICATIONS

This application claims priority under 35 U.S.C. 119(e) to U.S. Provisional Patent Application Ser. No. 61/616,186, filed Mar. 27, 2012, the teachings of which are incorporated herein.

### TECHNICAL FIELD

This invention relates to a technique for previewing a color-graded image.

### BACKGROUND ART

The process of producing a motion picture feature presentation usually includes a “post-production” phase during which images (frames) within motion picture feature presentation undergo processing, including color grading. An individual or team of individuals, typically referred to as “colorists,” will change the color attributes of selected images within the motion picture feature presentation under the supervision of the movie's director and/or director of photography to achieve a desired appearance. Such color attributes can include hue, saturation, and gamma. Color grading of selected images in such a manner affords the ability to enhance the motion picture feature presentation beyond the color properties of the original camera negative film stock, or in the case of a digitally originated movie, the color properties of the digital camera(s) that originally captured the images.

As the sophistication of consumer digital photography has increased, so too has the desire of consumers to perform many of the same kind of advanced post-production techniques used in the motion picture film industry, including color grading. While tools exist for consumers to perform some post-production activities, such as color grading, such tools typically operate by rendering the original image file, a time consuming process that can permanently change the image file. Thus, if a consumer becomes dissatisfied with the color grading, recovering the original image file can prove difficult or even impossible.

Thus, a need exists for a technique that allows for previewing an image file color graded in a desired manner without the need for image rendering.

### BRIEF SUMMARY OF THE INVENTION

Briefly, in accordance with a preferred embodiment of the present principles, a method for previewing a color graded image commences by first obtaining color metadata corresponding to a sample image appearance selected by a user from among a set of different sample image appearances, each sample image appearance having associated color metadata. The color metadata corresponding to the selected sample image appearance is stored with an image file the user has selected for color grading. The color metadata corresponding to the selected sample image appearance is applied to the image file to generate a preview of the image file, as it would appear when color graded with the color metadata.

### BRIEF SUMMARY OF THE DRAWINGS

FIG. 1 depicts a block schematic diagram of a system, in accordance with a preferred embodiment of the present principles, for previewing a color graded image preview;

FIG. 2 depicts an exemplary graphical user interface associated with the system of FIG. 1

FIG. 3 depicts a portion of the system of FIG. 1 operative during saving of the color grading information; and

FIG. 4 depicts a portion of the system of FIG. 1 operative during playback of an image for color grading preview in the manner described with respect to FIG. 1.

### DETAILED DESCRIPTION

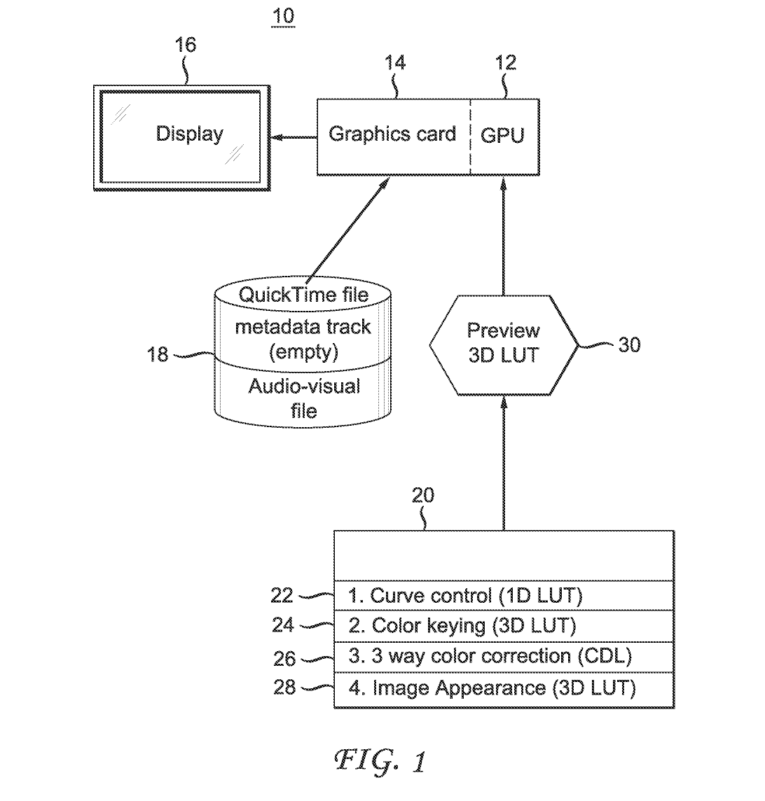

FIG. 1 depicts a block schematic diagram of a system 10, in accordance with a preferred embodiment of the present principles for previewing a color-graded image. The system 10 includes a graphics processing unit (GPU) 12 well known in the art for rapidly manipulating and altering a memory(not shown) to accelerate the building of images in a frame buffer for output to a display. User input to the GPU 12 typically occurs through one or more user input devices, such as a mouse and keyboard (both not shown in FIG. 1). The GPU 12 includes a graphics card 14 as are well known in the art for driving a display device 16, such as a color monitor. The graphics card 14 can take the form of circuitry contained on the motherboard of the GPU 12 or a separate circuit board with video processing circuitry. Graphics cards are available from a variety of manufacturers, including eVGA, ASUS, Matrox, and Vision Tek for example.

The system 10 also includes a first fie system 18 for storing incoming audio-visual files which typically, although not necessarily, are formatted in the Apple®“Quick Time” format. (The incoming audio-visual files could have other formats without departing from the present principles.) Typically, each the audio-visual files stored in the file system 18 represents at least a portion of a motion picture or video program, with or without accompanying audio. The audio-visual files stored in the file system 18 each have a track for storing color metadata for color grading the stored audio-visual file. The metadata track associated with each audio-visual file typically is empty upon initial ingest (i.e., initial importation) into the file system 18, thus allowing accommodation of the later-generated color metadata.

In addition to the file system 18, the system 10 includes a file system 20 that stores color metadata in the form of: (1) a color curve control three-dimensional (3D) look-up table (LUT) 22, a color keying 3D look-up table 24, a 3-way color decision list (CDL) 26 and an Image Appearance 3D LUT 28. Data from the Image Appearance LUT 28, together with data from the color curve control LUT 22, the color keying 24 LUT 24, and the 3-way color decision list 26 get combined to generate a set of values stored in a preview 3D LUT 30. The GPU 12 makes use of the values in the preview LUT 30 to color grade a user-selected audio-visual file stored in the file system 18 for preview on the display 16. Typically, the GPU 12 performs the color grading for image preview purposes following image decoding by shading the individual pixels in the selected audio-visual file using a 3D LUT (not shown).

The Image Appearance LUT 28 contains at least one, and preferably, a plurality of sets of predetermined color metadata created in advance of color grading for image preview in accordance with the present principles. Typically, the sets of predetermined color metadata will include the original file information (“no color grading) and a plurality of different color grades or looks. Each set of color metadata within the Image appearance LUT, when applied to a selected audio-visual file stored in the file system 18, whether as part of a preview operation, or as part of a rendering operation, will impart a certain appearance (e.g., a certain “look”) to the images in that file. For example, one set of color metadata, when applied to a selected audio-visual file, will cause the images therein to have a particular color hue. Another set of color metadata, when applied to the selected audio-visual will impart a different hue. Thus, each of the various sets of color metadata stored in the Image Appearance LUT 28, when applied to a selected audio-visual file, will alter the appearances of the images in a particular manner. By selecting a particular one of the sets of color metadata, a user can achieve a desired image appearance without having to determine the appropriate values for the color metadata in advance. Note that a user could select multiple sets of color metadata for application to a selected image in succession, rather than select a single set.

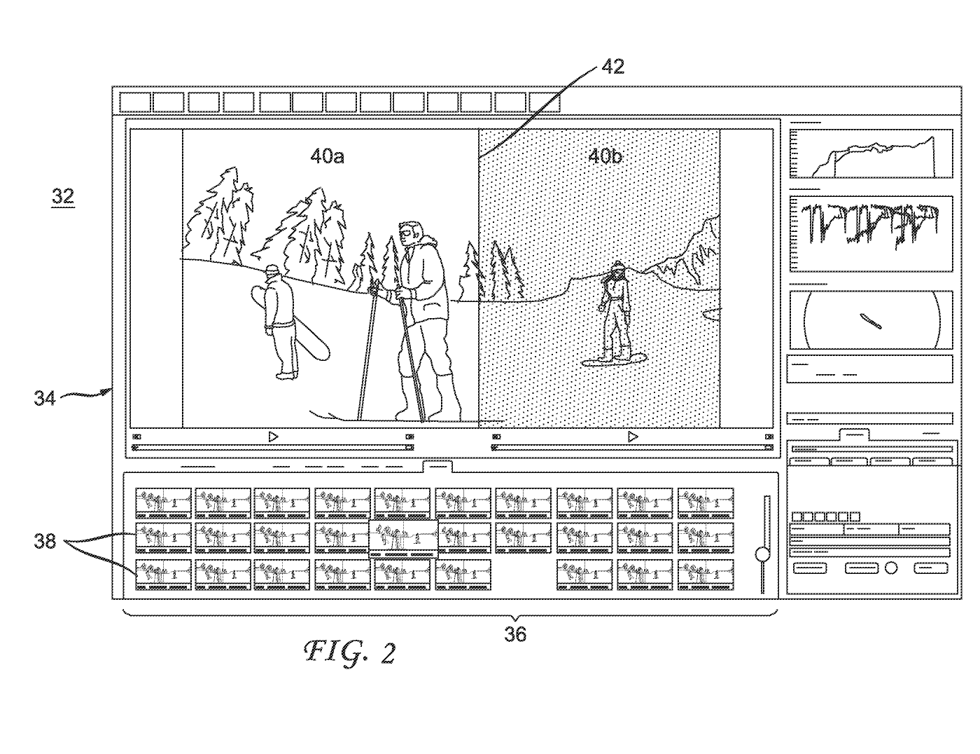

To facilitate user selection of a desired image appearance, the user will make use of a graphical user interface (GUI) 34 depicted in FIG. 2. The GUI 34 of FIG. 2, generated by the GPU 12 of FIG. 1, typically includes a main display window 34 showing a current frame of a selected audio-visual file downloaded from the file system 18 of FIG. 1. The GUI 32 also includes an image appearance library 36, comprised of a plurality of small images 38, hereinafter referred to as “thumbnails.” Each of the thumbnails 38 represents the current frame appearing in the window 34 rendered with a separate one of the sets of color metadata obtained from the Image Appearance LUT 28. Thus, the user can select a desired color metadata set by selecting the corresponding thumbnail 38 based on the appearance of that thumbnail.

The user can advantageously split the image in the main window 34 by dragging the same movie clip into the original image, thus creating two sections 40a and 40b divided by a vertical separator 42. Typically, the user will leave one copy of the clip, typically image appearing in the left hand section 40a of the main window 34, in its original form (i.e., without application of the selected set of color metadata). The user can then apply a selected set of color metadata to the clip appearing in the right-hand section 40b obtain a desired “look” for that clip. In other words, the right-hand section 40b depicted in the main window 34 of the GUI 32 of FIG, 2 depicts the current image frame of the selected audio-visual file as if it were color graded in accordance with the selected set of color metadata. In practice, the user can displace the vertical separator 42 to vary the relative size of the sections 40a and 40 to increase or decrease the size of one image relative to the other typically for the purpose of comparing the original image with the color graded image.

Referring to FIG. 1, the curve control LUT 22 and the color keying LUT 24, along with the 3-way color correction CDL 26, provide mechanisms for allowing the user manually adjust the color grading achieved from application of the selected set of color metadata described previously. The curve control LUT 24 contains a set of color metadata values, which vary in accordance with a particular color parameter, which when plotted, gives rise to a curve of a particular shape. In practice the GUI 32 will provide the user with a control (not shown) such as a knob of the like which the user can manipulate to increase or decrease the particular color parameter, for example, gamma, hue, or saturation, for example. Although FIG. 1 depicts a single curve control 1D LUT 22, the file system 20 could contain a plurality of 1D LUTs, each corresponding to a single curve for a separate one of a set of color parameters. Further, the LUT 22 could easily comprise one or more a 3D curve controls, rather than 1D curve controls.

The color keying LUT 24 contains values associated with color keying, a post-production tool, which allows for color isolation. Using the color keying LUT, a user can put a color key on a particular object in a scene to change the object of that color.

The 3-way color correction CDL 26 contains information indicative of color correction (i.e., color grading) operations applied previously to other audio-visual image files. Using the information in the color correction CDL 26, a user can select one or more of color correction operations for application to the selected image in addition to application of the color metadata set selected from the Image appearance LUT 28 in the manner described previously.

As discussed previously, data from the Image Appearance LUT 28, together with data from the color curve control LUT 22, the color keying 24 LUT 24, and the 3-way color decision list 26 get combined to generate the values stored in the preview 3D LUT 30. However, a user need not make manual image adjustments involving all or any the Image Appearance LUT 28, together with data from the color curve control LUT 22, the color keying 24 LUT 24, and the 3-way color decision list 26. Thus, data from some or all of the Image Appearance LUT 28, and the color curve control LUT 22, the color keying 24 LUT 24, and the 3-way color decision list 26 need not get folded with the data from the Image Appearance LUT 28.

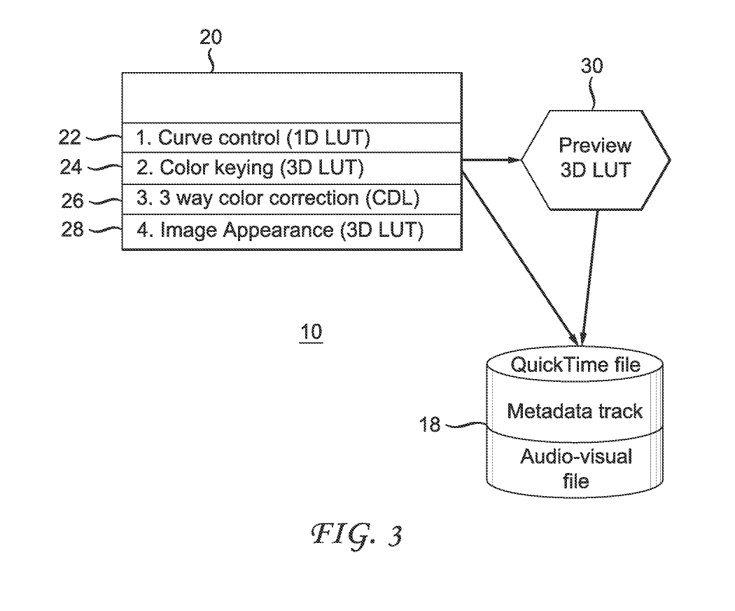

FIG. 3 depicts a potion of the system 10 of FIG. 1 showing the manner in which color grading information gets stored. As discussed previously, each audio-visual file stored in the file system 18 includes a metadata track initially empty. After user selection of a stored audio-visual downloaded from the file system, color metadata, representing data from the Image Appearance LUT 28, the color curve control LUT 22, the color keying 24 LUT 24, and the 3-way color decision list 26, is stored on the metadata track typically in the form of XML data. In addition, data from the preview LUT 30 is also stored on the metadata track of the selected audio-visual file as well. Storing the color metadata as part of the audio-visual file simplifies the process of tracking the color correction as well as the audio-visual file itself. As will become better understood hereinafter, the process of previewing the desired color grading involves application of the color metadata in connection with image display and does not require actual rendering of the selected audio-visual file. Thus, the selected audio-visual file remains in its original form, which saves time, disk space and removes the issues of tracking which color corrections belongs to which file.

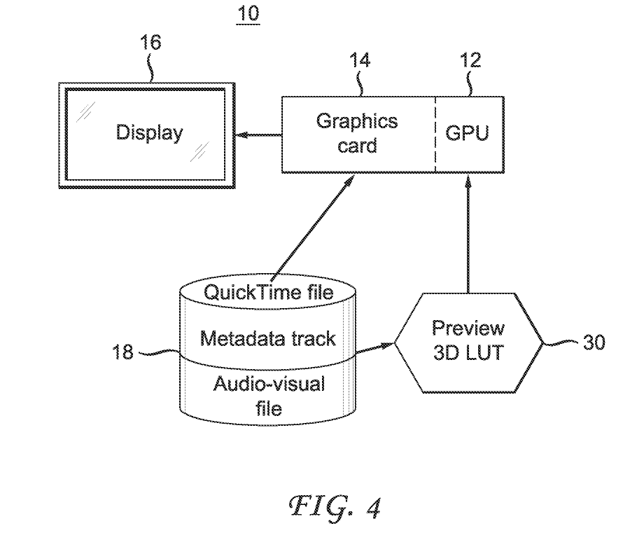

FIG. 4 depicts a portion of the system 10 illustrating image preview (i.e., playback) of the selected audio-image file with the color grading associated with the selected image appearance, as modified by the user. The color metadata, representing data from the Image Appearance LUT 28, as well as the color curve control LUT 22, the color keying 24 LUT 24, and the 3-way color decision list 26, stored on the metadata track, is combined at the preview 3D LUT 30 and thereafter sent to the GPU 12. At the GPU 12, the data from the preview 3D LUT 30 is applied to the selected audio-visual file, with the aid of the graphics care 14 to generate an image preview color graded with the color metadata.

The foregoing describes a technique for previewing a color-graded image.

1. A method for image preview with enhanced color grading, comprising the steps of:
obtaining color metadata corresponding to a sample image appearance selected by a user from among a set of different sample image appearances, each having corresponding color metadata;
storing with an image file the color metadata corresponding to the selected sample image appearance;
applying to the image file the color metadata corresponding to the selected sample image appearance to generate a preview of the image file.

2. The method according to claim 1 including the step of modifying the color metadata corresponding to the sample image appearance in response to user input.

3. The method according to claim 2 wherein the color metadata is modified in response to user selection of at least one value from a curve control look-up table.

4. The method according to claim 2 wherein the color metadata is modified in response to user selection of at least one value from a color keying look-up table.

5. The method according to claim 2 wherein the color metadata is modified in response to user selection of at least one value from a color correction decision list.

6. Apparatus for image preview with enhanced color grading, comprising,
a first file system for storing a set of sample image appearances, each having corresponding color metadata; and
a second file system containing at least one audio visual file;
processor means for (1) downloading from the first file system a sample image appearance selected by a user, (2) for storing with an image file the color metadata corresponding to the selected sample image appearance; and (3) applying to the image file the color metadata corresponding to the selected sample image appearance to generate a preview of the image file.

7. The apparatus according to claim 6 wherein the processor means modifies the color metadata corresponding to the sample image appearance in response to user input.

8. The apparatus according to claim 6 wherein the processor means modifies the color metadata corresponding to the sample image appearance in response to user selection of at least one value from a curve control look-up table.

9. The apparatus according to claim 6 wherein the processor means modifies the color metadata corresponding to the sample image appearance in response to user selection of at least one value from a color keying look-up table.

10. The apparatus according to claim 6 wherein the processor means modifies the color metadata corresponding to the sample image appearance in response to user selection of at least one value from a color correction decision list.
